(19) United States
(12) Patent Application Publication
(10) Pub. No.: US 2023/0053207 A1
(43) Pub. Date: Feb. 16, 2023

(54) STOWABLE STAIRS WITH LIFT ASSIST

(71) Applicant: Lippert Components, Inc., Elkhart, IN (US)

(72) Inventor: Bryan J. Roth, Topeka, IN (US)

(21) Appl. No.: 17/883,893

(22) Filed: Aug. 9, 2022

Related U.S. Application Data
(60) Provisional application No. 63/231,868, filed on Aug. 11, 2021.

(51) Int. Cl. B60R 3/02

(52) U.S. Cl. CPC B60R 3/02

(57) ABSTRACT

A lift assist hinge for stowable stairs facilitates deployment and stowing. The lift assist hinge includes a mounting bracket securable to a door frame and including a mounting bracket hinge flange. A threshold plate is securable between the stringers and is pivotable with the stowable stairs. A threshold plate hinge flange connected between the threshold plate and the mounting bracket hinge flange is pivotable relative to the mounting bracket hinge flange. A cam slot is disposed in the threshold plate hinge flange, and a gas spring is connected at one end to the mounting bracket hinge flange and at an opposite end in the cam slot of the threshold plate hinge flange. The opposite end of the gas spring is displaceable in the cam slot.

### CROSS-REFERENCES TO RELATED APPLICATIONS

This application claims the benefit of U.S. Provisional Patent Application No. 63/231,868, filed Aug. 11, 2021, the entire content of which is herein incorporated by reference.

### STATEMENT REGARDING FEDERALLY SPONSORED RESEARCH OR DEVELOPMENT

(NOT APPLICABLE)

### BACKGROUND

The invention relates to a stowable stair carrier and lift assist hinge for use in connection with an entry door and doorway of a mobile structure or other structure. More specifically, the invention relates to a lift assist hinge for stowable stairs that facilitates stair deployment and stowing.

A mobile structure, for example, a recreational vehicle (RV) or trailer, or other structure includes an interior space defined, in part, by a floor and a wall having a first (or inner) side and a second (or outer) side. The wall typically includes a doorway through which a user may pass to enter and exit the interior space. The floor is often positioned a substantial distance above the ground upon which the structure is situated. As such, it is desirable to provide the mobile structure with stairs to better enable passage between the floor and the ground.

In order to avoid interference with the environment when the mobile structure is in transit, the stairs typically are collapsible or removable. Conventional collapsible stairs may require under-floor space to receive the collapsed stair carrier, thereby limiting possible stair locations and, consequently, possible door locations. Removable stairs can be awkward to manipulate and require storage space when removed.

### SUMMARY

The lift assist hinge of the described embodiments includes a threshold plate hinge flange that connects to the lift assist mechanism via a pivot connector to a mounting bracket hinge flange. A first proximal end of a gas spring or the like is pivotally fixed to an upper end of the mounting bracket hinge flange, and a second distal end of the gas spring slidingly engages a cam slot in the threshold plate hinge flange. The gas spring compresses as the stairs are deployed and extends as the stairs are stowed. A distal end of the gas spring is moving to a corresponding end of the cam slot before coming to a stop and pivoting against the threshold hinge plate for the duration of movement of the stairs.

In an exemplary embodiment, a lift assist hinge is provided for stowable stairs. The stowable stairs include stringers and a plurality of treads connected between the stringers. The lift assist hinge includes a mounting bracket securable to a door frame and including a mounting bracket hinge flange, a threshold plate securable between the stringers and pivotable with the stowable stairs, and a threshold plate hinge flange connected between the threshold plate and the mounting bracket hinge flange. The threshold plate hinge flange is pivotable relative to the mounting bracket hinge flange. A cam slot is disposed in the threshold plate hinge flange, and a gas spring is connected at one end to the mounting bracket hinge flange and at an opposite end in the cam slot of the threshold plate hinge flange. The opposite end of the gas spring is displaceable in the cam slot.

The gas spring may be configured to bias the lift assist hinge to a position in which the stowable stairs are in a stowed position.

The threshold plate hinge flange may be connected to the mounting bracket hinge flange via a pivot connector, and the threshold plate hinge flange may be pivotable with the stowable stairs about the pivot connector. The door frame may include a threshold, and the threshold plate may engage the threshold with the stowable stairs in a deployed position. The pivot connector may be positioned so that a pivot axis of the threshold plate hinge flange may be above the threshold. The pivot connector may be a bolt.

The lift assist hinge may include two gas springs connected between the mounting bracket hinge flange and the threshold plate hinge flange. The lift assist hinge may be pivotable between a stowed position and a deployed position, and the opposite end of the gas spring may be positioned at one end of the cam slot with the lift assist hinge in the stowed position. The gas spring may be positioned at an opposite end of the cam slot with the lift assist hinge in the deployed position.

The opposite end of the gas spring may be connected in the cam slot of the threshold plate hinge flange via a cam pin that extends through the threshold plate hinge flange in the cam slot. The mounting bracket hinge flange may include a notch for receiving the cam pin.

The threshold plate hinge flange may include a right angle bracket including threshold section secured to the threshold plate and a mounting bracket section pivotably secured to the mounting bracket hinge flange.

In another exemplary embodiment, a stowable stair assembly cooperable with a door frame having a threshold includes stowable stairs including a pair of stringers and a plurality of treads connected between the stringers, where the stowable stairs are pivotable between a stowed position and a deployed position. The lift assist hinge of the described embodiments is connected between the stowable stairs and the door frame.

### BRIEF DESCRIPTION OF THE DRAWINGS

These and other aspects and advantages will be described in detail with reference to the accompanying drawings, in which:

FIG. 1 is a perspective view of the lift assist hinge and stowable stairs according to the described embodiments;

FIG. 2 is an alternative perspective view;

FIG. 3 shows the stowable stairs in an intermediate position between the stowed and deployed positions; and

FIG. 4 shows the stowable stairs in a deployed position.

### DETAILED DESCRIPTION

With reference to the drawings, an exemplary stowable stair assembly is shown including a lift assist hinge. The stowable stairs are configured for installation and use in connection with a mobile structure such as a recreational vehicle, trailer or the like. A door frame in the structure is typically provided with a header, a threshold (or sill), and first and second jams extending between the header and the threshold. A door may be pivotably attached to the door frame and latchable between the door jams.

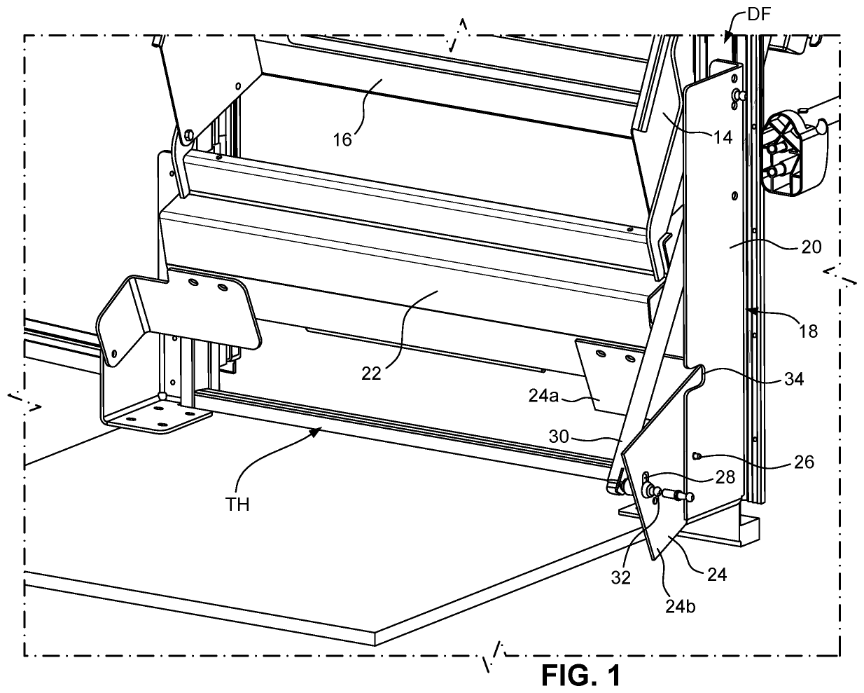

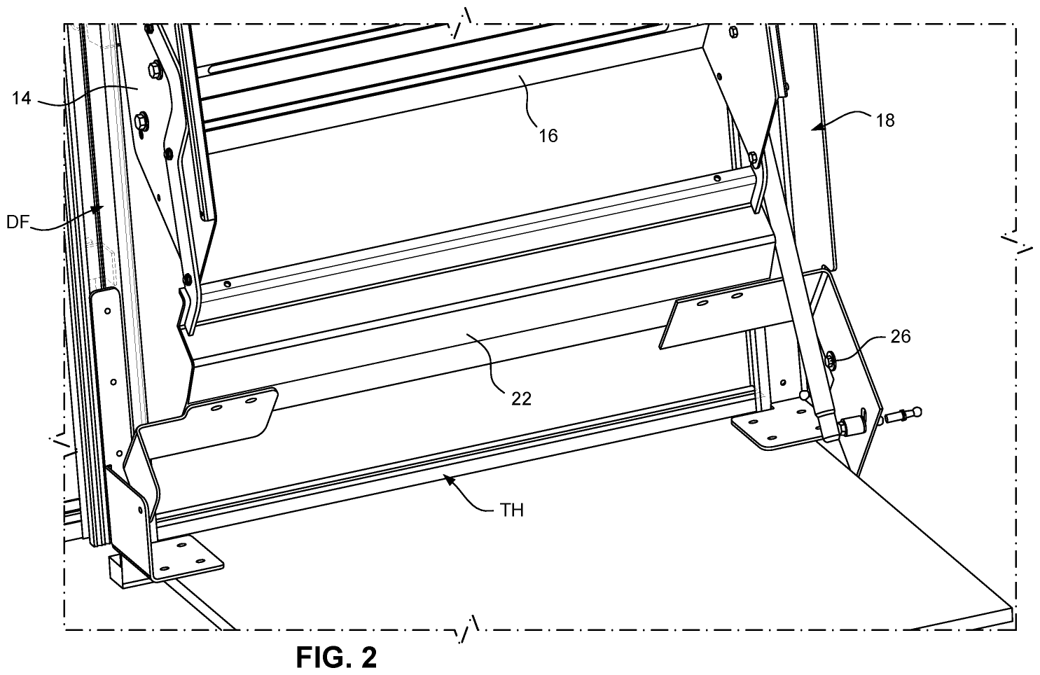

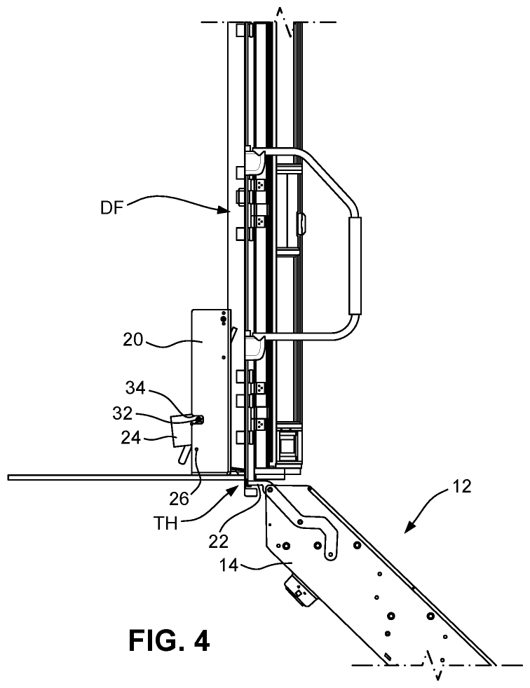

The stowable stair assembly is configured for attachment to the structure and stowable to a position within its interior space. The stowable stair assembly is pivotable between a stowed position (FIGS. 1 and 2) and a deployed position (FIG. 4). The lift assist hinge of the described embodiments facilitates deployment and stowing of the stowable stair assembly.

With reference to drawings, the stowable stair assembly 12 includes stringers 14 and a plurality of treads 16 connected between the stringers 14. The stair assembly 12 is operably coupled with the door frame DF, which includes a threshold TH.

The lift assist hinge is connected between the door frame DF and the stowable stair assembly 12 to facilitate deployment and stowing of the stowable stairs. The lift assist hinge includes a mounting bracket 18 securable to the door frame DF and including a mounting bracket hinge flange 20. A threshold plate 22 is securable between the stringers 14 and is pivotable with the stowable stairs 12. A threshold plate hinge flange 24 is connected between the threshold plate 22 and the mounting bracket hinge flange 20. The threshold plate hinge flange 24 is connected to the mounting bracket hinge flange 20 via a pivot connector 26 such as a bolt or the like. The threshold plate hinge flange 24 may be in the form of a right angle bracket including a threshold section 24a secured to the threshold plate 22 and a mounting bracket section 24b pivotably secured to the mounting bracket hinge flange 20. The threshold plate hinge flange 24 is pivotable with the stowable stairs 12 relative to the mounting bracket hinge flange 20 about the pivot connector 26.

A cam slot 28 is provided in the threshold plate hinge flange 24. A strut such as a gas spring 30 or the like is connected at one end to the mounting bracket hinge flange 20 and at an opposite end in the cam slot 28 of the threshold plate hinge flange 24. The opposite end of the gas spring 30 is displaceable/slidable in the cam slot 28. The gas spring 30 is configured to bias the lift assist hinge to a position in which the stowable stairs are in the stowed position. That is, the gas spring 30 compresses as the stowable stairs are deployed and extends as the stowable stairs are stowed. The opposite end of the gas spring 30 slides to a corresponding end of the cam slot 28 before coming to a stop and pivoting against the threshold plate hinge flange 24 for the duration of the displacement of the stowable stairs.

In some embodiments, the lift assist hinge will include two gas springs 30 on opposite sides of the threshold plate 22. Only one gas spring 30 is shown in FIGS. 1 and 2 for simplicity.

As shown in FIG. 4, the threshold plate 22 engages the threshold TH with the stowable stairs 12 in the deployed position. The pivot connector 26 is positioned so that a pivot axis of the threshold plate hinge flange 24 is above the threshold TH.

In some embodiments, the opposite end of the gas spring 30 is connected in the cam slot 28 of the threshold plate hinge flange 24 via a cam pin 32 that extends through the threshold plate hinge flange 24 in the cam slot 28. In this context, the mounting bracket hinge flange 20 may be provided with a notch 34 for receiving the cam pin 32 when the stair assembly is deployed (see FIG. 4).

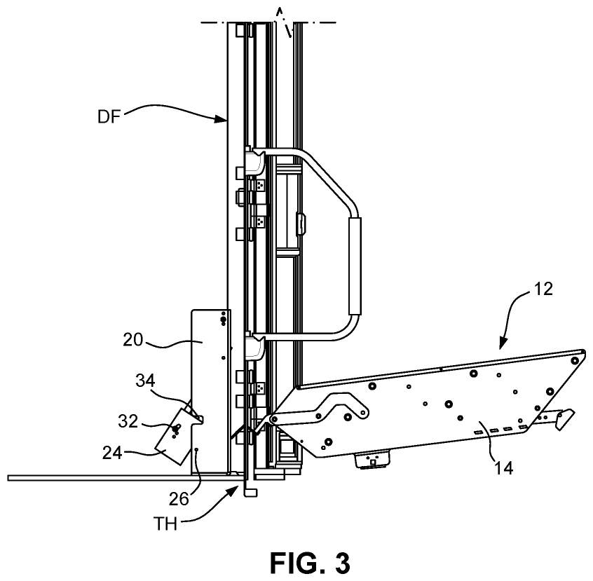

In use, the gas strut 30 is compressed/contracted with the stowable stairs in the deployed position. That is, in the position shown in FIG. 4, the threshold plate hinge flange 24 is pivoted from the position shown in FIG. 1 to a position in which the end of the gas spring 30 in the cam slot 28 is closest to the end of the gas spring 30 that is fixed to the mounting bracket hinge flange 20. As the stowable stairs are pivoted from the deployed position shown in FIG. 4, through the intermediate position shown in FIG. 3 and to the position shown in FIGS. 1 and 2, the gas spring 30 extends to assist in lifting/pivoting the stowable stairs toward the stowed position. When actuating the stowable stairs, the gas strut 30 supports some of the weight of the stowable stairs to facilitate deployment and stowing.

The lift assist hinge of the described embodiments is readily securable between a stowable stair assembly and a door frame in a mobile structure. As would be appreciated by those of ordinary skill in the art, the lift assist hinge and stair assembly could be used in combination with a fixed structure. The lift assist hinge facilitates deployment and stowing of the stair assembly.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

1. A lift assist hinge for stowable stairs, the stowable stairs including stringers and a plurality of treads connected between the stringers, the lift assist hinge comprising:
a mounting bracket securable to a door frame and including a mounting bracket hinge flange;
a threshold plate securable between the stringers and pivotable with the stowable stairs;
a threshold plate hinge flange connected between the threshold plate and the mounting bracket hinge flange, wherein the threshold plate hinge flange is pivotable relative to the mounting bracket hinge flange;
a cam slot disposed in the threshold plate hinge flange; and
a gas spring connected at one end to the mounting bracket hinge flange and at an opposite end in the cam slot of the threshold plate hinge flange, wherein the opposite end of the gas spring is displaceable in the cam slot.

2. A lift assist hinge according to claim 1, wherein the gas spring is configured to bias the lift assist hinge to a position in which the stowable stairs are in a stowed position.

3. A lift assist hinge according to claim 1, wherein the threshold plate hinge flange is connected to the mounting bracket hinge flange via a pivot connector, and wherein the threshold plate hinge flange is pivotable with the stowable stairs about the pivot connector.

4. A lift assist hinge according to claim 3, wherein the door frame includes a threshold, and wherein the threshold plate engages the threshold with the stowable stairs in a deployed position, the pivot connector being positioned so that a pivot axis of the threshold plate hinge flange is above the threshold.

5. A lift assist hinge according to claim 3, wherein the pivot connector is a bolt.

6. A lift assist hinge according to claim 1, comprising two gas springs connected between the mounting bracket hinge flange and the threshold plate hinge flange.

7. A lift assist hinge according to claim 1, wherein the lift assist hinge is pivotable between a stowed position and a deployed position, and wherein the opposite end of the gas spring is positioned at one end of the cam slot with the lift assist hinge in the stowed position, and the gas spring is positioned at an opposite end of the cam slot with the lift assist hinge in the deployed position.

8. A lift assist hinge according to claim 1, wherein the opposite end of the gas spring is connected in the cam slot of the threshold plate hinge flange via a cam pin that extends through the threshold plate hinge flange in the cam slot.

9. A lift assist hinge according to claim 8, wherein the mounting bracket hinge flange comprises a notch for receiving the cam pin.

10. A lift assist hinge according to claim 1, wherein the threshold plate hinge flange comprises a right angle bracket including threshold section secured to the threshold plate and a mounting bracket section pivotably secured to the mounting bracket hinge flange.

11. A stowable stair assembly cooperable with a door frame having a threshold, the stowable stair assembly comprising:
stowable stairs including a pair of stringers and a plurality of treads connected between the stringers, the stowable stairs being pivotable between a stowed position and a deployed position; and
a lift assist hinge connected between the stowable stairs and the door frame, the lift assist hinge including:
a mounting bracket securable to the door frame and including a mounting bracket hinge flange,
a threshold plate secured between the stringers and pivotable with the stowable stairs,
a threshold plate hinge flange connected between the threshold plate and the mounting bracket hinge flange, wherein the threshold plate hinge flange is pivotable relative to the mounting bracket hinge flange,
a cam slot disposed in the threshold plate hinge flange, and
a gas spring connected at one end to the mounting bracket hinge flange and at an opposite end in the cam slot of the threshold plate hinge flange, wherein the opposite end of the gas spring is displaceable in the cam slot.

12. A stowable stair assembly according to claim 11, wherein the gas spring is configured to bias the lift assist hinge to a position in which the stowable stairs are in the stowed position.

13. A stowable stair assembly according to claim 11, wherein the threshold plate hinge flange is connected to the mounting bracket hinge flange via a pivot connector, and wherein the threshold plate hinge flange is pivotable with the stowable stairs about the pivot connector.

14. A stowable stair assembly according to claim 13, wherein the threshold plate engages the threshold with the stowable stairs in a deployed position, the pivot connector being positioned so that a pivot axis of the threshold plate hinge flange is above the threshold.

15. A stowable stair assembly according to claim 13, wherein the pivot connector is a bolt.
